(19) United States
(12) Patent Application Publication
(10) Pub. No.: US 2010/0086664 A1
(43) Pub. Date: Apr. 8, 2010

(54) CAPSULES FROM SEPARATED POLYMER SOLUTIONS

(75) Inventors: Albert Thijs Poortinga, Apeldoorn (NL); Ramona Maria Henricus Prickaerts, Hoogeveen (NL)

Correspondence Address: HOFFMANN & BARON, LLP, 6900 JERICHO TURNPIKE, SYOSSET, NY, 11791, US

(73) Assignee: FRIESLAND BRANDS B.V., Meppel (NL)

(21) Appl. No.: 12/514,832

(22) PCT Filed: Nov. 15, 2007
(86) PCT No.: PCT/NL2007/050568

§ 371 Date: Nov. 18, 2009

(30) Foreign Application Priority Data
Nov. 15, 2006 (NL) 1032873

(51) Int. Cl. A23C 19/00; A23J 1/00; A23G 3/00; A23C 9/154; A23C 21/00

(52) U.S. Cl. 426/582; 426/531; 426/656; 426/658; 426/580; 426/583

(57) ABSTRACT

The invention relates to a method of preparing a double emulsion comprising a) preparing an emulsion comprising at least two liquid phases by bringing a first polymer (A) and a second polymer (B) into contact with each other in a solvent, wherein the concentrations of the polymers are chosen such that, upon bringing them into contact, a phase separation occurs, thereby forming drops of a first liquid phase in a second liquid phase, wherein, in the first phase, the weight concentration of the polymer A (C_{A}) is higher and the weight concentration of the polymer B (C_{B}) is lower than the respective concentrations in the second phase; b) dispersing the emulsion in a third liquid phase, which third phase comprises the polymer A in a C_{A} which is higher than in the second phase and the polymer B in a C_{B} which is lower than in the second phase, thereby forming the double emulsion, comprising at least one discontinuous phase (1)—with a relatively high C_{A} and a relatively low C_{B}—enclosed by a surrounding phase (2)—with a relatively low C_{A} and a relatively high C_{B}—which discontinuous and surrounding phase are dispersed in a continuous phase (3)—with a relatively high C_{A} and a relatively low C_{B}; and wherein the solvent in said liquid phases is the same or the solvents are at least, in the absence of the polymers, soluble in one another or completely miscible at 25° C.

The invention relates to a double emulsion, to a method for the preparation thereof, to a method for the preparation of particles utilizing a double emulsion, and particles obtainable by means of such a method.

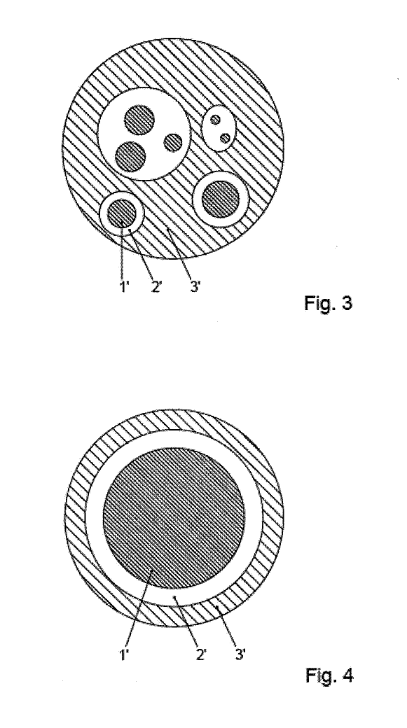

In this specification, particles with a hierarchical structure are particles composed of different substances, in particular particles having therein one or more compartments of a first substance which are surrounded by a second substance, for instance as shown in FIG. 3 or 4 which schematically show particles according to the present invention.

Particles with a hierarchical structure have various uses. Thus, particles of an active substance, such as a medicinal product or a nutrient, can be surrounded by a protective layer (as by means of encapsulation) to protect the active substance from undesired effects from the environment and/or to protect the environment from the active substance.

A common method of manufacturing particles with a hierarchical structure comprises coating core particles with a second material. Such a method is described in WO 01/051196.

WO 01/28530 describes a method where water-insoluble particles, such as starch particles or particles of modified cellulose, are introduced into a solution of an active substance and a capsule material in ethanol so as to be dispersed. The active substance thereby penetrates into the insoluble particles. By drying, also the capsule precipitates on the particles. Such a method is not suitable for manufacturing capsules whose core, or at least a part thereof, is liquid.

Coating liquid drops is described in WO 03/018186. Therein, from the continuous phase, dissolved substances are precipitated on the drops. This technique is limited to drops which do not dissolve in the continuous phase (in which the capsule material is dissolved) and therefore the capsule material typically has a polarity which differs considerably from the core material. For instance, one material is soluble in oil and the other in water.

WO 04/02220 describes the preparation of encapsulated particles from an oil in water emulsion. A drawback of this technique is that it is not suitable for encapsulating a polar substance with a polar capsule material.

It is an object of the invention to provide a new method of preparing particles, in particular particles with a hierarchical structure, more in particular particles with a core-shell morphology.

It is further an object of the invention to provide a new method of preparing particles with a hierarchical structure where particles are composed of two or more polar (water-soluble) substances.

One or more objects which can be achieved by means of the invention follow from the rest of the specification and/or claims.

It has now been found that it is possible to prepare particles with a hierarchical structure from a particular type of double emulsion.

Therefore the invention relates to a method of preparing a double emulsion, comprising

a) preparing an emulsion comprising at least two liquid phases by bringing a first polymer (A) and a second polymer (B) (with A and B being different from each other) into contact with each other in a solvent, wherein the concentrations of the polymers are chosen such that, upon bringing them into contact, a phase separation occurs, thereby forming drops of a first liquid phase in a second liquid phase, wherein, in the first phase, the weight concentration of the polymer A (C_{A}) is higher and the weight concentration of the polymer B (C_{B}) is lower than the respective concentrations in the second phase; the method can be carried out most simply such that the separation is not complete, so that preferably both polymers are present in both phases;
b) dispersing the emulsion in a third liquid phase, which third phase comprises a polymer A in a C_{A} which is higher than in the second phase and the polymer B in a C_{B} which is lower than in the second phase, thereby forming the double emulsion, comprising at least one discontinuous phase (1)—with a relatively high C_{A} and a relatively low C_{B}—enclosed by a surrounding phase (2)—with a relatively low C_{A} and a relatively high C_{B}—which discontinuous and surrounding phase are dispersed in a continuous phase (3)—with a relatively high C_{A} and a relatively low C_{B}; and wherein the solvent in these phases is the same or the solvents are at least, in the absence of the polymers, soluble in one another or completely miscible at the temperature at which the emulsion is prepared.

Polymers A in the first phase and the third phase may be the same or different polymers, preferably the same or at least of the same class, in particular both polysaccharides or both proteins.

Polymer A and polymer B are different from each other. Preferably, they are of different classes.

The polymers A and B are usually edible, i.e. suitable for human consumption.

In the Figures:

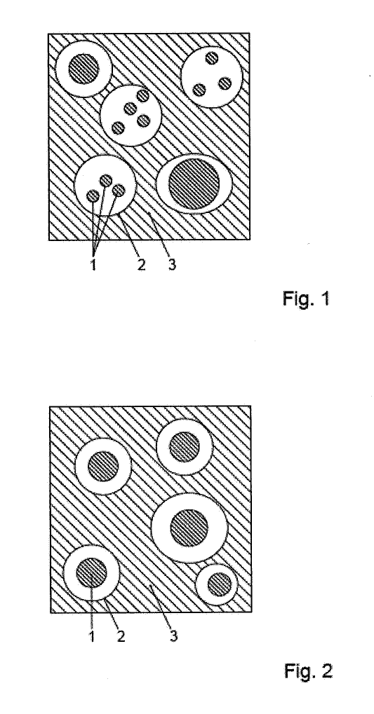

FIG. 1 schematically shows a double emulsion;

FIG. 2 schematically shows a double emulsion in which particles with a core-shell morphology are emulsified;

FIG. 3 shows a particle according to the invention, where various compartments (1′ surrounded by 2′) are present in the external phase 3′;

FIG. 4 shows a particle according to the invention with a core-shell morphology, composed of a core 1′, an intermediate shell 2′ and an outer shell 3′; and

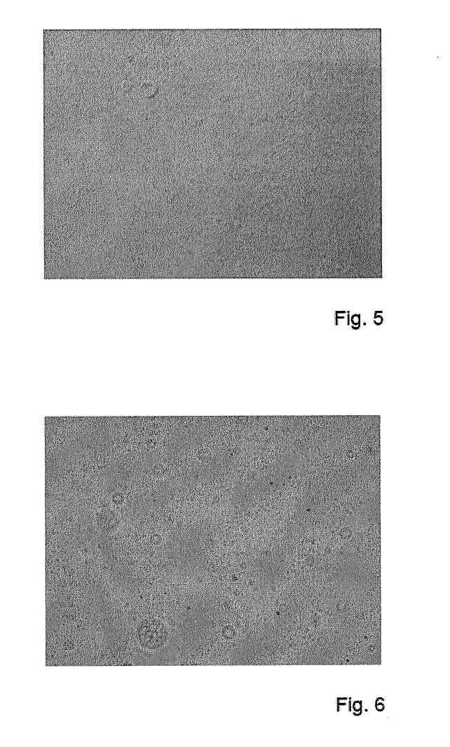

FIGS. 5-8 show images of particles according to the invention.

Surprisingly, it has been found possible, by means of the invention, to obtain a double emulsion in which (liquid) particles are present which comprise the first and the second phase, while the second phase at least substantially encloses the first phase and while in at least the greater part of those particles, at least the greater part of the volume of the enclosed phase is, if desired, located in one drop (as schematically shown in FIG. 2).

Such a double emulsion is extremely suitable for readily preparing particles with a core-shell morphology, such as capsules with an optionally liquid core and a solid shell. Particles with such a morphology can have one or more advantages compared to particles in which the content of the particles is distributed over a large number of compartments (e.g. droplets). Thus, there is a clearly distinctive core with well-controllable properties which may be different from those of the capsule. Also, a particle with such a morphology can contain more internal phases. Further, the release of the internal material can be better controlled or at least differently effected. A microcapsule with a core-shell morphology will, for instance, be able to burst open under the influence of shearing forces, and thus all at once release its content completely or at least substantially instantaneously.

The preparation of the emulsion in step (a) of a method of preparing a double emulsion is based on the principle that solutions of two or more types of polymers (A and B, respectively) can separate when they are present in a particular concentration. Here, at least two phases are created, with the polymer A mainly ending up in one phase and polymer B in the other. In this manner, an emulsion can be created in which one phase is dispersed in the other phase as small drops. The continuous and the dispersed phase then contain at least substantially the same liquid; the driving force behind the maintenance of the emulsion are the polymers. In the case that water is the solvent, this is also referred to as a water-in-water emulsion.

Very suitable for the preparation of the emulsion is a method where a solution is prepared which contains polymer A and a solution which contains polymer B. Then, both solutions are combined, after which separation occurs, thereby forming the emulsion. A particularly suitable method of combining the solutions is injecting a solution of one polymer into a solution of the other polymer.

If desired, in step (a), an active ingredient can be emulsified, in particular an active ingredient chosen from the group consisting of peptides, thickeners, enzymes and carbohydrates.

Then, in step (b), the emulsion is dispersed in the third liquid phase. To this end, injecting the emulsion into the third phase is very suitable.

As polymer A and polymer B, in particular biopolymers have been found suitable. Preferably, polymer A and/or B are chosen from the group consisting of peptides, proteins and polysaccharides, in particular from the group consisting of whey proteins (such as beta lactoglobulins, alpha lactalbumin, immunoglobulins), casein, caseinate, alginate, dextran, starch, pectin, cellulose, including derivates thereof. Such polymers are suitable for use in a food.

Preferably, polymer A is a protein and polymer B a polysaccharide or polymer A is a polysaccharide and polymer B a protein. Preferably, at least polymer B can be gelled in water or an aqueous solution and/or can be cross-linked.

Suitable concentrations for the polymers A, A and B can be determined empirically depending on the chosen polymers. As a rule, a concentration, based on weight, is suitable which is such that C_{A} in the discontinuous phase and C_{A} in the continuous phase are 2-50 times higher than in the surrounding phase and/or C_{B} in the discontinuous phase and in the continuous phase is 2-50 times lower than in the surrounding phase. This allows preparing an emulsion where there is no or hardly any exchange of polymers between the different phases.

In principle, any solvents can be used for the liquid phases (provided that they are soluble in one another). So, the solvent may be polar or non-polar. Preferably, the solvent for each of the liquid phases is polar, i.e. water or water-miscible or water-soluble. Particularly suitable are liquids chosen from the group consisting of water, aqueous solvents and water-miscible solvents, such as water-miscible alcohols, in particular methanol, ethanol, propanol, glycerol; water-miscible ketones, such as acetone; and mixtures thereof.

Further, it has been found advantageous to choose the components of the phases such that the viscosity of the first (discontinuous) phase and of the third (continuous) phase is lower than the viscosity of the second (intermediate) phase.

The invention further relates to a double emulsion, such as a double emulsion obtainable by means of a method according to one of the preceding claims, comprising a discontinuous phase (1) present in a surrounding phase (2), which are together dispersed in a continuous phase (3), wherein

the discontinuous phase comprises a first solvent, a polymer A and a polymer B, wherein the weight concentration of the polymer A (C_{A}) is relatively high and the weight concentration of polymer B (C_{B}) is relatively low compared to the respective concentrations in the surrounding phase;

the surrounding phase (2) comprises a second solvent, a polymer B and a polymer A, wherein the concentration of polymer B is relatively high and the concentration of polymer A is relatively low;

the continuous phase (3) comprises a third solvent, a polymer A and optionally a polymer B, wherein the weight concentration of the polymer A (C_{A}) is relatively high and the weight concentration of polymer B (C_{B}) is relatively low compared to the surrounding phase;

and wherein the first, second and third solvent are the same or are at least, in the absence of the polymers, soluble in one another at ambient temperature, in particular at about 25° C.

An emulsion according to the invention has been found particularly suitable for the preparation of liquid and/or solid particles. Therefore, the invention relates to a method of preparing liquid particles, such as drops, comprising removing at least a part of the continuous phase from a double emulsion according to the invention, and to liquid particles (drops) thus obtainable.

In one embodiment of an emulsion according to the invention, the discontinuous phase (1) and the surrounding phase (2) together form liquid particles with a “core-shell” morphology, with the discontinuous phase (1) as a core and the surrounding phase (2) as a shell. In such an embodiment, the particles with “core-shell” morphology are preferably particles of which at least 90 vol. % of the discontinuous phase consists of one core (drop).

From a double emulsion according to the invention, liquid particles, such as drops, can be isolated by separating at least a part of the continuous phase from the particles (comprising the discontinuous and surrounding phase) in the double emulsion. This can be done by means of a filtering technique known per se, preferably after cross-linking or gelling of the surrounding phase.

The double emulsion is particularly suitable for preparing solid particles. Herein, “solid” means that at least the external layer is solid, so that the particle as a whole behaves like a solid particle.

To this end, if desired, particularly the polymer B can be fixed after formation of the double emulsion, preferably by means of precipitation, cross-linking or gelling, in at least the surrounding phase. Thus, stable microcapsules can be obtained. Suitable fixing techniques are known, depending on the polymer B.

Certain polymers, such as certain proteins, can be cross-linked by means of heating (with sulfur bridges providing the cross-linking), such as for instance whey proteins like beta lactoglobulin and alpha lactalbumin. Certain carbohydrates, such as alginates, pectin, and the like, can be cross-linked by addition of cations such as calcium. A number of polymers can be cross-linked by acidification or under the influence of an enzyme. Chemical cross-linking reactions (by reaction with a cross-linking agent) are also possible.

The solid particles can be separated from the liquid, in particular by filtering, and, if desired, be dried and/or be added to any phase, preferably a food.

The invention also relates to particles, such as particles obtainable by means of a method according to the invention, comprising an internal phase (1′) enclosed by a surrounding phase (2′), wherein

the surrounding phase (2′) comprises a polymer B and a polymer A;

the internal phase (1′) comprises a solvent, a polymer A and a polymer B, wherein the weight concentration of the polymer A (C_{A}) is relatively high and the weight concentration of polymer B (C_{B}) is relatively low compared to the surrounding phase.

In one embodiment, the particles comprising the internal phase 1′ and the surrounding phase 2′ are surrounded by an external phase 3′, with the external phase typically being edible and preferably being a food, most preferably a food chosen from the group of fruit juices and dairy products, such as milk, cheese, yoghurt, custard, soft curd cheese, dairy beverages, cream and the like.

Such particles can be prepared according to the invention by dispersing the particles comprising the internal phase 1′ and the surrounding phase 2′, preferably after cross-linking at least the surrounding phase 2′ in a liquid substance intended for forming the external phase, which is preferably a food or a liquid composition containing the food. If desired, the formed dispersion can be dried, particularly spray-dried, whereby particles can be formed as for instance shown in FIG. 3.

It is possible by means of the invention to combine the bulk properties of one material with the surface properties of another material, which can be advantageous in numerous uses.

The dimensions of the particles can be chosen within a broad range. In particular, the invention relates to essentially spherical particles.

The number-average particle size is preferably at least 1 μm, in particular at least 5 μm. The number-average particle size is preferably at most 100 μm, in particular at most 50 μm. The particle size is determinable by means of microscopy.

In particular, the invention relates to a food comprising particles according to the invention. In a preferred embodiment, the food comprises microcapsules whose core comprises a carbohydrate and the envelope a protein. Such microcapsules have an interaction with proteins like they are protein particles. As a result, these particles can be included in protein networks as found in a food such as a dairy product, for instance cheese or yoghurt. Thus, foods can be provided with texture in an inexpensive manner.

Such particles can also be used to encapsulate a thickener. It is also possible to provide capsules which can be made to burst open in a controlled manner, which enables a controlled thickening of foods.

In one embodiment, the solid particles (in particular capsules) contain an internal phase comprising carbohydrates, such as sugars or oligosaccharides, for which it can be advantageous to release them in a controlled manner, for instance in a delayed manner, after consumption.

It is also possible to add one or more components to the internal phase of the capsules. Thus, for instance, healthy but poorly tasting peptides can preferably end up in an internal phase with protein as a dominant polymer therein, surrounded by a phase with polysaccharide as a dominant polymer therein.

It is also possible to encapsulate an enzyme.

Controlled release can be realized by subjecting the particles to a shearing stress which makes them burst open.

The invention will now be illustrated in and by the following Examples.

### EXAMPLE 1

2 ml of a 30% β lactoglobulin (BL) solution in water were injected with a 1.1-mm syringe at a rate of about 1 ml/s into 2 ml of a 4% methylcellulose (MC) solution in water. Both phases were mixed well by sucking up the mixture with the syringe and spraying it out again a few times. This resulted in a phase-separated solution with drops with predominantly BL therein in a continuous solution with predominantly MC. Three milliliters of this solution were injected into 9 ml of BL solution. By repeatedly sucking up and spraying out the thus formed mixture with the syringe, a good mixing was obtained. Observation with the aid of interference contrast microscopy of the resulting solution provided the image shown in FIG. 5.

The drops in FIG. 5 are formed by a solution with predominantly MC with drops of solution therein with predominantly BL therein. The continuous phase is a solution with predominantly BL. Surprisingly, the MC drops are predominantly virtually completely filled with only a single BL drop, i.e. capsules with a so-called core-shell morphology have been formed.

### EXAMPLE 2

3 ml of a 12% caseinate solution in water were injected into 6 ml of a 2% alginate solution. Of the resulting ‘emulsion’, 2 ml were injected into 18 ml of caseinate solution. An interference contrast microscopic image of the resulting emulsion is shown in FIG. 6.

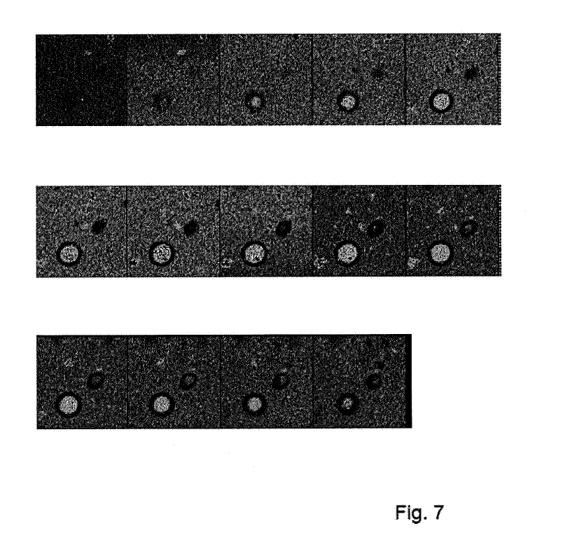

Then the alginate was cross-linked by adding 0.2% calcium chloride to the solution. Ten times diluting the particle suspension thus obtained did not result in the particles dissolving, so they are stable. To the solution, a protein dye was added and the solution was examined with the aid of CSLM microscopy (FIG. 7). This allows making optical cross sections of the particles at different depths (from left to right, from top to bottom, each time the image is 1 micrometer deeper into the solution). The images show that a spherical particle is obtained with a core-shell morphology.

### EXAMPLE 3

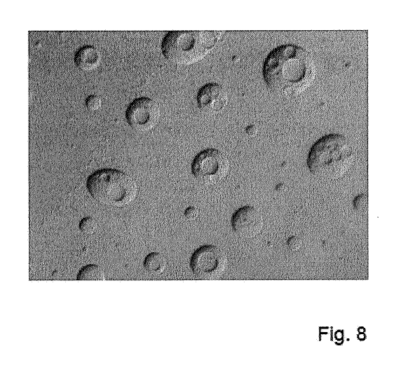

2 ml of an alginate solution was stirred through 8 ml of a 13% caseinate solution. One milliliter of this solution was mixed through 19 ml of a 2.5% alginate solution with the aid of a syringe. This resulted in drops of caseinate solution filled with alginate-containing drops in a continuous alginate solution. FIG. 8 shows an image of the drops formed.

1. A method of preparing a double emulsion, comprising
a) preparing an emulsion comprising at least two liquid phases by bringing a first edible polymer (A) and a second edible polymer (B) into contact with each other in a solvent, wherein the concentrations of the polymers are chosen such that, upon bringing them into contact, a phase separation occurs, thereby forming drops of a first liquid phase in a second liquid phase, wherein, in the first phase, the weight concentration of the polymer A (C_{A}) is higher and the weight concentration of the polymer B (C_{B}) is lower than the respective concentrations in the second phase;
b) dispersing the emulsion in a third liquid phase, which third phase comprises an edible polymer A in a C_{A} which is higher than in the second phase and the polymer B in a C_{B} which is lower than in the second phase, thereby forming the double emulsion, comprising at least one discontinuous phase (1)—with a relatively high C_{A} and a relatively low C_{B}—enclosed by a surrounding phase (2)—with a relatively low C_{A} and a relatively high C_{B}—which discontinuous and surrounding phase are dispersed in a continuous phase (3)—with a relatively high C_{A} and a relatively low C_{B}; and
wherein the solvent in said liquid phases is the same or the solvents are at least, in the absence of the polymers, soluble in one another or completely miscible at the temperature at which the emulsion is prepared.

2. A method according to claim 1, wherein, in each of the phases, at least one solvent is present for the polymers, chosen from the group consisting of water, aqueous solvents, and water-miscible solvents, such as a water-miscible alcohol or ketone, and wherein the solvent is preferably water or a liquid which consists at least substantially of water.

3. A method according to claim 1, wherein the polymer A and/or B is chosen from the group consisting of biopolymers, in particular from the group consisting of proteins and polysaccharides, more in particular from the group consisting of whey proteins (such as beta lactoglobulins, alpha lactalbumin, immunoglobulins), casein, dextran, caseinate, alginate, starch, pectin, cellulose, including derivatives thereof.

4. A method according to claim 3, wherein the polymer A in the discontinuous phase and the polymer A in the continuous phase are the same or different polysaccharides and polymer B is a protein or wherein the polymer A in the discontinuous phase and the polymer A in the continuous phase are the same or different proteins and polymer B is a polysaccharide.

5. A method according to claim 1, wherein (c) polymer B is precipitated, in particular cross-linked or gelled, in at least the surrounding phase.

6. A method according to claim 1, wherein, in step (a), an active ingredient is emulsified, in particular an active ingredient chosen from the group consisting of peptides, enzymes, carbohydrates and thickeners.

7. A double emulsion, such as a double emulsion obtainable by means of a method according to claim 1, comprising a discontinuous phase (1) present in a surrounding phase (2), which are together dispersed in a continuous phase (3), wherein
the discontinuous phase comprises a first solvent, an edible polymer A and an edible polymer B, wherein the weight concentration of the polymer A (C_{A}) is relatively high and the weight concentration of polymer B (C_{B}) is relatively low compared to the respective concentrations in the surrounding phase;
the surrounding phase (2) comprises a second solvent, an edible polymer B and an edible polymer A;
the continuous phase (3) comprises a third solvent, an edible polymer A and optionally an edible polymer B, wherein the weight concentration of the polymer A (C_{A}) is relatively high and the weight concentration of polymer B (C_{B}) is relatively low compared to the surrounding phase;
and wherein the first, second and third solvent are the same or are at least, in the absence of the polymers, soluble in one another or completely miscible at ambient temperature.

8. An emulsion according to claim 7, wherein the discontinuous phase (1) and the surrounding phase (2) together form liquid particles with a “core-shell” morphology, with the discontinuous phase (1) as a core and the surrounding phase (2) as a shell.

9. An emulsion according to claim 8, wherein the particles with “core-shell” morphology are particles of which at least 90 vol. % of the discontinuous phase within an enveloping phase is located in a single drop.

10. An emulsion according to claim 7, wherein at least 60 vol. % of the particles are particles with a “core-shell” morphology.

11. An emulsion according to claim 7, wherein the solvents are chosen from the group consisting of water, aqueous solvents, and water-miscible solvents, such as a water-miscible alcohol or ketone, and wherein the solvent is preferably water or a liquid which consists at least substantially of water, the polymer A and/or the polymer B is chosen from the group consisting of biopolymers, in particular from the group consisting of proteins and polysaccharides, more in particular from the group consisting of whey proteins (such as beta lactoglobulins, alpha lactalbumin, immunoglobulins), casein, dextran, caseinate, alginate, starch, pectin, cellulose, including derivatives thereof wherein the polymer A in the discontinuous phase and the polymer A in the continuous phase are the same or different polysaccharides and polymer B is a protein or wherein the polymer A in the discontinuous phase and the polymer A in the continuous phase are the same or different proteins and polymer B is a polysaccharide.

12. An emulsion according to claim 11, wherein, in each of the phases, the solvent is water or an aqueous solution.

13. An emulsion according to claim 7 wherein C_{A} in the discontinuous phase and/or C_{A} in the continuous phase is 2-50 times higher than in the surrounding phase and/or C_{B} in the discontinuous phase and in the continuous phase is at least 2 times lower than in the surrounding phase.

14. An emulsion according to claim 7, wherein the discontinuous phase further comprises an active ingredient, in particular an active ingredient chosen from the group consisting of thickeners, peptides, enzymes and carbohydrates.

15. A method of preparing liquid particles, such as drops, comprising removing at least a part of the continuous phase from an emulsion according to claim 1.

16. Drops, such as drops obtainable by means of a method according to claim 14, comprising a discontinuous phase (1) present in a surrounding phase (2), wherein
the discontinuous phase comprises a first solvent, an edible polymer A and an edible polymer B, wherein the weight concentration of the polymer A (C_{A}) is relatively high and the weight concentration of polymer B (C_{B}) is relatively low compared to the respective concentrations in the surrounding phase;
the surrounding phase (2) comprises a second solvent, an edible polymer B and an edible polymer A;
and wherein the first and second solvent are the same or are at least, in the absence of the polymers, soluble in one another or completely miscible at ambient temperature.

17. A method of preparing solid particles from an emulsion according to claim 1, comprising cross-linking one or more polymers in the surrounding phase and optionally then removing at least a part of the continuous phase, and optionally drying the remaining composition, comprising said discontinuous phase and surrounding phase.

18. A method of preparing solid particles comprising drying an emulsion according to claim 1.

19. Solid particles, such as particles obtainable by means of a method according to claim 17, comprising an internal phase (1′) enclosed by a surrounding phase (2′), wherein
the surrounding phase (2′) comprises an edible polymer B and an edible polymer A;
the internal phase (1′) comprises a solvent, an edible polymer A and an edible polymer B, wherein the weight concentration of the polymer A (C_{A}) is relatively high and the weight concentration of polymer B (C_{B}) is relatively low compared to the surrounding phase.

20. Solid particles, such as particles obtainable by means of a method according to claim 17, comprising an internal phase (1′) enclosed by a surrounding phase (2′), which surrounding phase (2′) is enclosed by an external phase (3′), wherein
the surrounding phase (2′) comprises an edible polymer B and an edible polymer A;
the external phase (3′) preferably comprises a food; and wherein
the internal phase (1′) comprises a polymer A and a polymer B, wherein the weight concentration of the polymer A (C_{A}) is relatively high and the weight concentration of polymer B (C_{B}) is relatively low compared to the surrounding phase.

21. Drops according to claim 16, wherein the polymer A and/or the polymer B from the polymers is chosen from the group consisting of biopolymers, in particular from the group consisting of proteins and polysaccharides, more in particular from the group consisting of whey proteins (such as beta lactoglobulins, alpha lactalbumin, immunoglobulins), casein, dextran, caseinate, alginate, starch, pectin, cellulose, including derivatives thereof wherein the polymer A in the discontinuous phase and the polymer A in the continuous phase are the same or different polysaccharides and polymer B is a protein or wherein the polymer A in the discontinuous phase and the polymer A in the continuous phase are the same or different proteins and polymer B is a polysaccharide and/or the solvents from the solvents chosen in the group consisting of water, aqueous solvents, and water-miscible solvents, such as a water-miscible alcohol or ketone, and wherein the solvent is preferably water or a liquid which consists at least substantially of water.

22. Drops according to claim 16, wherein C_{A} in the internal phase and/or C_{A} in the external phase is 2-50 times higher than in the surrounding phase and/or C_{B} in the internal phase and/or in the external phase is at least 2 times lower than in the surrounding phase.

23. Drops according to claim 16, wherein at least the internal phase and the surrounding phase together form particles with a “core-shell” morphology, wherein the internal phase forms the core and the surrounding phase the shell.

24. Drops according to claim 21, wherein at least 50 vol. % of the internal phase is present in particles with a “core-shell” morphology.

25. Drops according to claim 16, wherein the internal phase contains at least one active ingredient, in particular an active ingredient chosen from the group consisting of thickeners, peptides, enzymes and carbohydrates.

26. Drops according to claim 25, wherein the internal phase is liquid, and preferably contains water.

27. Drops according to claim 16, wherein both the internal phase and the external phase are hydrophilic (water-soluble).

28. A food comprising drops according to claim 16, preferably a dairy product, more preferably cheese or yoghurt.

29. A method of preparing liquid particles, such as drops, comprising removing at least a part of the continuous phase from an emulsion according to claim 7.

30. A method of preparing solid particles from an emulsion according to claim 7, comprising cross-linking one or more polymers in the surrounding phase and optionally then removing at least a part of the continuous phase, and optionally drying the remaining composition, comprising said discontinuous phase and surrounding phase.

31. A method of preparing solid particles comprising drying an emulsion obtained by means according to claim 1.

32. A method of preparing drops comprising drying an emulsion obtained by means according to claim 15.

33. A method of preparing drops comprising drying an emulsion obtained by means according to claim 16.

34. Solid particles according to claim 19 wherein the polymer A and/or the polymer B from the polymers is chosen from the group consisting of biopolymers, in particular from the group consisting of proteins and polysaccharides, more in particular from the group consisting of whey proteins (such as beta lactoglobulins, alpha lactalbumin, immunoglobulins), casein, dextran, caseinate, alginate, starch, pectin, cellulose, including derivatives thereof wherein the polymer A in the discontinuous phase and the polymer A in the continuous phase are the same or different polysaccharides and polymer B is a protein or wherein the polymer A in the discontinuous phase and the polymer A in the continuous phase are the same or different proteins and polymer B is a polysaccharide, and/or the solvents from the solvents chosen in the group consisting of water, aqueous solvents, and water-miscible solvents, such as a water-miscible alcohol or ketone, and wherein the solvent is preferably water or a liquid which consists at least substantially of water.

35. Solid particles according to claim 19 wherein C_{A} in the internal phase and/or C_{A} in the external phase is 2-50 times higher than in the surrounding phase and/or C_{B} in the internal phase and/or in the external phase is at least 2 times lower than in the surrounding phase.

36. Solid particles according to claim 20 wherein C_{A} in the internal phase and/or C_{A} in the external phase is 2-50 times higher than in the surrounding phase and/or C_{B} in the internal phase and/or in the external phase is at least 2 times lower than in the surrounding phase.

37. Drops according to claim 21, wherein C_{A} in the internal phase and/or C_{A} in the external phase is 2-50 times higher than in the surrounding phase and/or C_{B} in the internal phase and/or in the external phase is at least 2 times lower than in the surrounding phase.

38. Solid particles according to claim 19, wherein at least the internal phase and the surrounding phase together form particles with a “core-shell” morphology, wherein the internal phase forms the core and the surrounding phase the shell.

39. Solid particles according to claim 20, wherein at least the internal phase and the surrounding phase together form particles with a “core-shell” morphology, wherein the internal phase forms the core and the surrounding phase the shell.

40. Solid particles according to claim 34, wherein at least 50 vol. % of the internal phase is present in particles with a “core-shell” morphology.

41. Solid particles according to claim 19, wherein the internal phase contains at least one active ingredient, in particular an active ingredient chosen from the group consisting of thickeners, peptides, enzymes and carbohydrates.

42. Solid particles according to claim 41, wherein the internal phase is liquid, and preferably contains water.

43. Solid particles according to claim 19, wherein both the internal phase and the external phase are hydrophilic (water-soluble).

44. A food comprising solid particles according to claim 19, preferably a dairy product, more preferably cheese or yoghurt.
